(19) United States
(12) Patent Application Publication
(10) Pub. No.: US 2018/0108106 A1
(43) Pub. Date: Apr. 19, 2018

(54) SYSTEM AND METHOD FOR DYNAMICALLY ALLOCATING RESOURCES AMONG GPU SHADERS

(71) Applicant: Advanced Micro Devices, Inc., Sunnyvale, CA (US)

(72) Inventor: Angel E. Socarras, Orlando, FL (US)

(21) Appl. No.: 15/298,026

(22) Filed: Oct. 19, 2016

(51) Int. Cl. G06T 1/20; G06T 1/60; G06T 15/80

(52) U.S. Cl. CPC G06T 1/20; G06T 15/80; G06T 1/60

(57) ABSTRACT

A GPU stores resource allocations for a plurality of shaders to process processing a graphics workload, and applies those stored resource allocations when the same or a similar graphics workload is received subsequently by the GPU. In response to receiving a new graphics workload with a given unique identifier for the first time, the GPU employs a series of performance monitors to measure performance characteristics for processing the workload. The GPU then calculates a resource allocation for the workload based on the performance characteristics, and stores the resource allocation. In response to subsequently receiving a previously stored graphics workload with the given identifier, the GPU retrieves the stored resource allocation for the graphics workload, and applies the resource allocation for processing the graphics workload.

### BACKGROUND

### Description of the Related Art

Graphics processing units (GPUs) are used in a wide variety of processors to facilitate the processing and rendering of objects for display. The GPU includes a plurality of processing elements, referred to as shaders, to execute instructions, thereby creating images for output to a display. Typically, an incoming instruction set, referred to as a graphics workload, will make varying demands on the shaders of the GPU, such that the one set of shaders may take a much longer time to complete their assigned tasks for a given workload than another set of shaders takes to complete their assigned tasks. Such a workload imbalance can create a processing bottleneck at the GPU and therefore have a detrimental impact on overall processing efficiency.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a GPU that assigns processing resources for processing a graphics workload based on stored characterization of the graphics workload in accordance with some embodiments.

FIG. 2 is a block diagram of an example of a control module of the GPU of FIG. 1 receiving a graphics workload and characterizing a resource allocation for the graphics workload in accordance with some embodiments.

FIG. 3 is a block diagram of an example of a resource allocation among a plurality of shaders of the GPU of FIG. 1 in accordance with some embodiments.

FIG. 4 is a flow diagram illustrating a method for characterizing and storing a resource allocation for a graphics workload by a GPU, and applying the resource allocation when the same or a similar graphics workload is subsequently received by the GPU in accordance with some embodiments.

### DETAILED DESCRIPTION

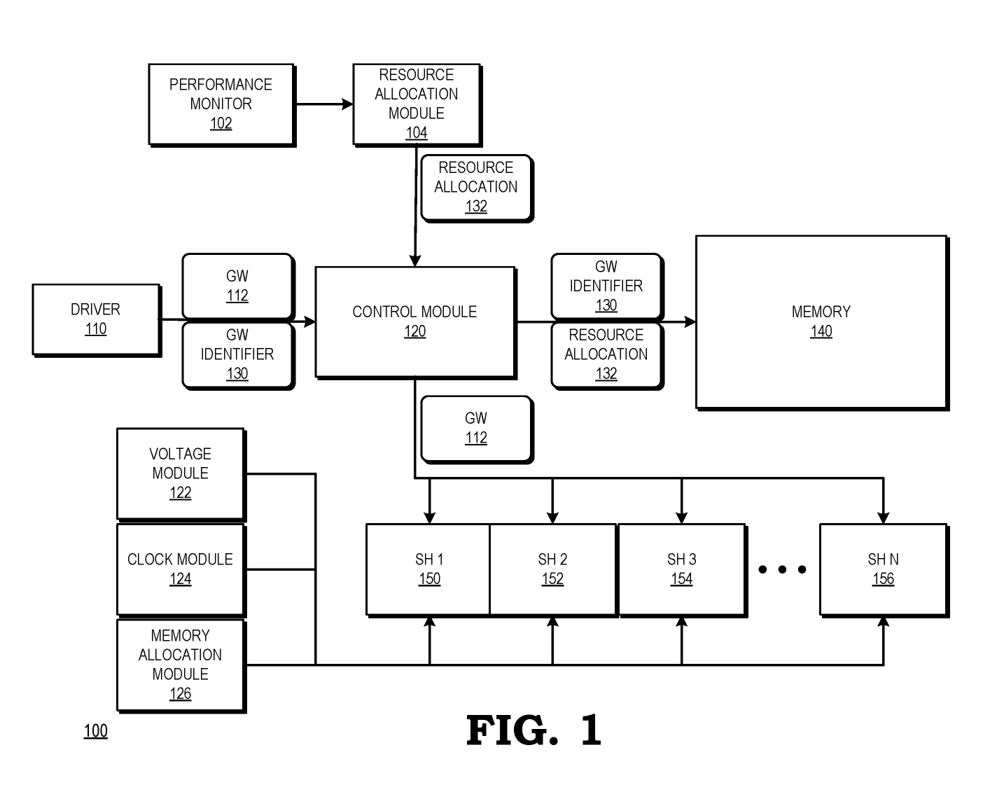

FIGS. 1-4 illustrate techniques for storing resource allocations among a plurality of shaders of a GPU for processing a graphics workload, and applying those stored resource allocations when the same or a similar graphics workload is received subsequently by the GPU. In response to receiving a new graphics workload with a given unique identifier for the first time, the GPU employs a series of performance monitors to measure performance characteristics for processing the workload. The GPU then calculates a resource allocation for the workload based on the performance characteristics, and stores the resource allocation. In response to subsequently receiving a previously stored graphics workload with the given identifier, the GPU retrieves the stored resource allocation for the graphics workload, and applies the resource allocation for processing the graphics workload. By applying the stored resource allocation, the GPU reduces processing bottlenecks and improve overall processing efficiency of the processor.

To illustrate, in many graphics applications, the same or a similar graphics workload is typically received by the GPU repeatedly. By creating a resource allocation for each graphics workload that adjusts resources such as applied voltage, clock frequency, engine configuration, and memory allocations for each shader, and storing the resource allocation with a workload identifier, the resource allocation may be recalled and applied for subsequent processing of the same or a similar graphics workload. The GPU thus dynamically adapts the resource allocations among shaders and other sub-engines to more efficiently process subsequent graphics workloads.

FIG. 1 illustrates an example of a GPU 100 configured to balance workloads across a plurality of shader in accordance with some embodiments. The GPU 100 is employed in any of a variety of devices, such as a personal computer, mobile device such as a smartphone, tablet, a video player, a video game console, a casino gaming device and the like. To support processing of graphics workloads, GPU 100 comprises a driver 110, control module 120, performance monitor 102, a resource allocation module 104, memory 140, voltage module 122, clock module 124, memory allocation module 126, and shaders SH1 (150), SH2 (152), SH3 (154), . . . SHN (156).

Driver 110 is a software module that controls how the GPU 100 interacts with the rest of the computer or device in which the GPU 100 is installed. In particular, the driver 110 provides an interface between the GPU 100 and the operating system and/or hardware of the device that includes the GPU 100. In at least one embodiment, the driver 110 supplies graphics workloads, such as graphics workload 112, to the GPU 100 for processing.

The graphics workload 112 is a set of graphics instructions that, when executed, result in the GPU 100 generating one or more objects for display. For example, the graphics workload 112 may be instructions for rendering a frame or portion of a frame of video or static graphics. The GPU 100 distributes the operations required by the graphics workload among the shaders 150-156. In particular, each of the shaders 150-156 is a processing element configured to perform specialized calculations and execute certain instructions for rendering computer graphics. For example, shaders 150-156 may compute color and other attributes for each fragment, or pixel, of a screen. Thus, shaders 150-156 may be two-dimensional (2D) shaders such as pixel shaders, or three-dimensional shaders such as vertex shaders, geometry shaders, or tessellation shaders, or any combination thereof. As described further herein, the shaders work in parallel to execute the operations required by graphics workload 112.

Each graphics workload 112 may present different computational demands for each of the plurality of shaders 150-160. Thus, for example, the graphics workload 112 could require shader SH1 150 to perform a large number of calculations while requiring shader SH2 152 to perform relatively fewer calculations. As a result of the disparate demands placed on the shaders 150 and 152, shader SH1 150 is likely to require a longer time to complete the tasks required by the graphics workload 112 than shader SH2 152 may complete its tasks for processing the graphics workload 112 in a shorter time. The longer time for task completion required by the more heavily tasked shader SH1 150 may create a bottleneck on the GPU 100, leading to decreased efficiency in processing the graphics workload 112. By redistributing resources such as a supplied voltage, clock frequency, and memory allocation available to each of shaders SH1 150 and SH2 152, such that shader SH1 150 is able to complete each of its assigned calculations at a faster rate than shader SH2 152, the likelihood or impact of a bottleneck is reduced.

To facilitate allocation of resources among the shaders 150-156, the GPU 100 includes a performance monitor 102, a resource allocation module 104, a control module 120, a voltage module 122, a clock module 124, and a memory allocation module 126. The performance monitor 102 is a module configured to record performance characteristics at different modules of the GPU 100, including the shaders 150-156. Thus, the performance monitor 102 records individual performance information for each of the shaders 150-156, such as cache hit rate, cache miss rate, instructions or operations per cycle executed at the shader, stalls at the shader, and the like. The performance monitor 102 thus records a performance profile across the shaders 150-156. In some embodiments, the performance monitor 102 records the performance information on a “per-workload” basis. That is, in response to the driver 110 providing a new workload to the GPU 100, the performance monitor 102 resets its stored performance information, so that at a given instance of time the performance information stored at the performance monitor 102 indicates performance characteristics for the currently executing, or most recently executed, graphics workload.

The resource allocation module 104 is generally configured to generate a resource allocation 132 for the shaders 150-156 based on performance information recorded by the performance monitor 102. In particular, the resource allocation module 104 is configured to generate the resource allocation 132 to allocate more resources to shaders having higher resource needs as indicated by the performance information recorded at the performance monitor 102. To illustrate, in some embodiments the resource allocation module 104 generates the resource allocation 132 to assign a voltage, clock frequency, and amount of memory resources to be allocated to each of the shaders 150-156. The resource allocation module 104 generates the resource allocation to assign a higher voltage, clock frequency, amount of memory resources, or a combination thereof, to shaders whose performance information indicates a higher processing demand at the shader. Thus, for example, if the performance information for a given shader indicates that the shader is generating a high number of memory access requests, the resource allocation module 104 generates the resource allocation 132 to assign a higher amount of memory resources to that shader than to shaders generating fewer memory access requests.

The control module 120, voltage module 122, clock module 124, and memory allocation module 126 are generally configured to supply resources to the shaders 150-156 based on the resource allocation 132. To illustrate, the voltage module 122 is generally configured to provide an individual reference voltage to each of the shaders 150-156, wherein each shader uses the reference voltage to set the threshold voltage for transistors and other components of the shader. The voltage module 122 sets the reference voltage for each shader individually, and may therefore set the reference voltage for one shader to a different level than the reference voltage for a different shader. The clock module 124 is configured to supply clock signals to each of the shaders 150-156, and may set the frequency of the clock signal supplied to each shader individually. Thus, the clock module 124 may supply a clock signal to one shader at a higher frequency than the clock signal supplied to a different shader. The memory allocation module 126 is configured to supply parameters to each of the shaders 150-156 indicating memory resources allocated to that shader. The parameters can include, for example, address information, pointer information, and the like indicating what memory resources have been assigned to a shader. The memory allocation module 126 may supply different parameters to different shaders, thereby assigning different memory resources to each shader.

The control module 120 is generally configured to control each of the voltage module 122, clock module 124, and memory allocation module 126, such that each module supplies resources to the shaders 150-156 according to the resource allocation 132. Thus, the control module 120 provides control signaling to the voltage module 122 so that the voltage module 122 provides reference voltages to the shaders 150-156, wherein the reference voltage provided to each shader is individually indicated by the resource allocation 132. Similarly, the control module 120 provides control signaling to the clock module 124 and the memory allocation module 126 so that the modules supply a clock signal and memory resource parameters, respectively, to the shaders 150-156 as indicated by the resource allocation 132. The control module 120 thereby allocates the resources of the GPU 100 to the shaders 150-156 individually according to the resource allocation 132. This allows the GPU 100 to individually tailor the resource allocation among the shaders 150-156 based on the graphics workload 112, reducing the likelihood that the workload will cause a bottleneck at one of the shaders 150-156, or reducing the duration of any such bottleneck.

In some embodiments, the recording of performance information by the performance monitor 102 and the generation of the resource allocation 132 by the resource allocation module 104 impacts performance at the GPU 100 by, for example, consuming power, reducing the speed with which the GPU 100 can execute operations, and the like. Accordingly, to reduce the performance impact, the GPU 100 records the resource allocation for a workload at a memory 140. In response to subsequently receiving the same or a similar workload from the driver 110, the GPU 100 applies the stored resource allocation to the shaders 150-156 to process the workload.

To illustrate, the driver 110 provides each workload to the GPU 100 with an accompanying workload identifier, such as workload identifier 130 for graphics workload 112. The control module 120 accesses the memory 140 to determine if there is a stored resource allocation corresponding to the workload identifier. If not, the control module 120 informs the resource allocation module and performance monitor 102, which together generate a resource allocation for the graphics workload as described above. Based on the resource allocation, the control module 120 controls the voltage module 122, clock module 124, and memory allocation module 126 to provide resources individually to the shaders 150-156. In addition, the control module 120 stores the resource allocation along with the corresponding workload identifier at the memory 140.

When the workload is again supplied by the driver 110 at a subsequent time, the control module 120 identifies that the workload identifier is stored at the memory 140. In response, the control module 120 retrieves the stored resource allocation from the memory 140, and controls the voltage module 122, clock module 124, and memory allocation module 126 to supply resources to the shaders 150-156 according to the stored resource allocation. By storing resource allocations at the memory 140 and applying the stored resource allocation for each instance of a given workload, the GPU 100 efficiently assigns resources for different workloads without significantly impacting processing performance.

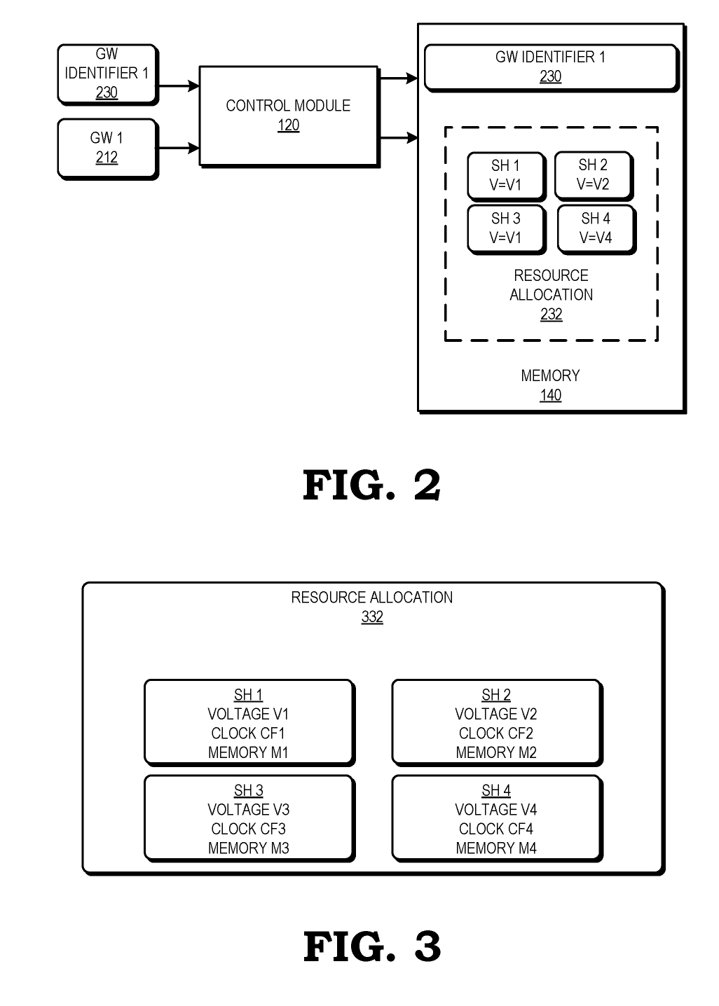

FIG. 2 illustrates an example of the control module 220 of the GPU 100 storing a resource allocation in accordance with some embodiments. In the depicted example, the control module 120 receives a graphics workload 212 and associated graphics workload identifier 230 from the driver 110 (not shown at FIG. 2). The control module 120 determines that the workload identifier 230 is not stored at the memory 140 and, in response, requests that the resource allocation module 104 generate a resource allocation 232. The control module 120 also stores the graphics workload identifier 230 and the resource allocation 232 to the memory 240 for later retrieval in the event that a graphics workload having the same associated graphics workload identifier 230 is subsequently received by the control module 120. Upon a subsequent receipt of a workload having the same associated graphics workload identifier 230, the control module 120 controls the voltage module 122, clock module 124, and memory allocation module 126 to provide resources to each of the shaders 150-156 in accordance with the resource allocation 232.

In the example of FIG. 2, the resource allocation 232 specifies that the voltages and/or clock frequencies supplied to each of four shaders SH1, SH2, SH3, SH4 are to be set as follows: shader SH1 is to be supplied with a voltage V1; shader SH2 is to be supplied with a voltage V2, shader SH3 is to be supplied with a voltage V1; and shader SH4 is to be supplied with a voltage V4. In some embodiments, voltage V1 is a default voltage, with which all shaders are supplied unless otherwise specified by the resource allocation 232. Voltage V2 is a higher voltage than voltage V1, and voltage V4 is a higher voltage than V2.

FIG. 3 illustrates an example of a resource allocation 332 with resource settings for each of four shaders SH1, SH2, SH3, and SH4. In this example, the resource allocation 432 specifies that for shader SH1, the voltage be set to voltage V1, the clock frequency be set to clock frequency CF1, and the memory allocation be set to memory allocation M1; for shader SH2 (not shown), the voltage be set to voltage V2, the clock frequency be set to clock frequency CF2, and the cache memory allocation be set to cache memory allocation M2; for shader SH3, the voltage be set to voltage V3, the clock frequency be set to clock frequency CF3, and the cache memory allocation be set to cache memory allocation M3; and for shader SH4, the voltage be set to voltage V4, the clock frequency be set to clock frequency CF4, and the cache memory allocation be set to cache memory allocation M4. In this example, one or more of the voltages V1, V2, V3, and V4 are different from the others. Similarly, one or more of the clock frequency values CF1, CF2, CF3, and CF4 are different than the others, and one or more of the memory allocations M1, M2, M3, and M4 are different from the others.

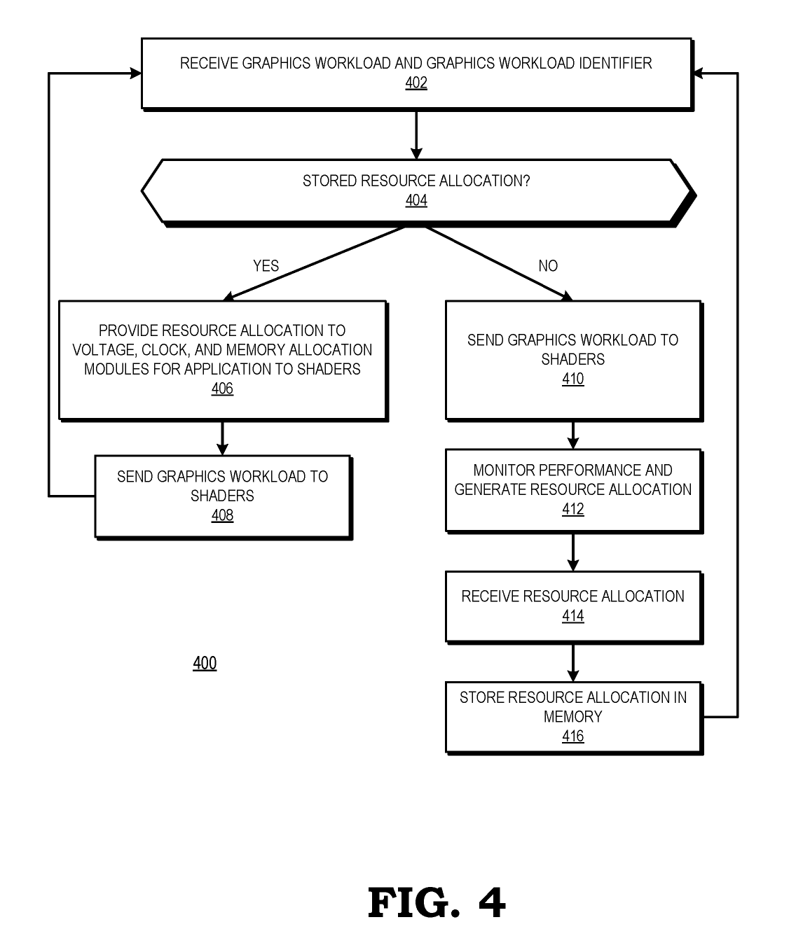

FIG. 4 illustrates a method 400 of allocating resources among a plurality of shaders for a received graphics workload based on a stored resource allocation in accordance with some embodiments. For purposes of description, the method 400 is described with respect to an example implementation at the GPU 100 of FIG. 1. At block 402, the driver 110 provides the GPU 100 with a workload and an identifier for the workload. At block 404, the control module 120 determines whether the received workload identifier is stored at the memory 140 along with a previously generated resource allocation. If so, the method flow proceeds to block 406, where the control module 120 retrieves the stored resource allocation and supplies control signaling to the voltage module 122, the clock module 124, and the memory allocation module 126 to provide, respectively, reference voltages, clock signals, and memory resource parameters to each of the shaders 150-156 consistent with the stored resource allocation. The method flow proceeds to block 408 and the control module 120 provides operations of the received workload to the shaders 150-156, which execute the operations using the allocated resources, as governed by the stored resource allocation. The method flow returns to block 402 for the GPU 100 to receive another graphics workload.

Returning to block 404, if the control module 120 determines that the memory 140 does not store an identifier for the received graphics workload, the method flow proceeds to block 410 and the control module 120 provides operations of the received workload to the shaders 150-156 for execution. In some embodiments, the control module 120 provides control signaling to the voltage module 122, the clock module 124, and the memory allocation module 126 to provide substantially equal resources to each of the shaders 150-156 to execute the operations, such as the same reference voltage, the same clock signal frequency, and similar memory allocation parameters. At block 412, the performance monitor 102 records performance information for the shaders 150-156 based on their execution of the operations for the received workload. Based on the performance information, the resource allocation module 104 generates a resource allocation for the shaders 150-156 to reduce potential bottlenecks for the workload. At block 411 the control module 120 receives the generated resource allocation and at block 416 the control module 120 stores the resource allocation at the memory 140 along with the identifier for the graphics workload upon which the resource allocation is based. The method flow returns to block 402 for the GPU 100 to receive another graphics workload.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
determining a shader resource allocation for a graphics workload received by a graphics engine;
storing the shader resource allocation; and
applying the shader resource allocation in response to the graphics workload being received by the graphics engine after storing the shader resource allocation.

2. The method of claim 1, wherein determining a shader resource allocation comprises:
determining the resources required for each of a plurality of shaders to execute the graphics workload.

3. The method of claim 2, wherein the resources comprise voltage applied to each of the plurality of shaders.

4. The method of claim 2, wherein the resources comprise a clock frequency applied to each of the plurality of shaders.

5. The method of claim 2, wherein the resources comprise a cache memory allocation applied to each of the plurality of shaders.

6. The method of claim 1, wherein storing comprises storing in a content addressable memory.

7. The method of claim 1, further comprising:
storing an identifier for the graphics workload; and
wherein applying the shader resource allocation comprises applying the shader resource allocation in response to the stored identifier matching an identifier for a received graphics workload.

8. A method comprising:
receiving a first graphics workload by a graphics engine;
determining a first resource allocation for the first graphics workload;
storing the first resource allocation; and
allocating resources in accordance with the stored first resource allocation in response to the first graphics workload being received by the graphics engine after determining the first resource allocation.

9. The method of claim 8, wherein determining the resource allocation comprises determining one or more of a voltage, clock frequency, and memory resource allocations to be applied to one or more graphics engine components when executing the graphics workload.

10. The method of claim 8, wherein storing the first resource allocation comprises storing the resource allocation in a content addressable memory.

11. The method of claim 8, further comprising:
storing an identifier for the graphics workload; and
wherein applying the first resource allocation comprises applying the first resource allocation in response to the stored identifier matching an identifier for a received graphics workload.

12. The method of claim 8, further comprising:
receiving a second graphics workload by the graphics engine;
determining a second resource allocation for the second graphics workload;
storing the second resource allocation; and
allocating resources in accordance with the second resource allocation when the second graphics workload is subsequently received by the graphics engine.

13. A device, comprising:
a control module configured to receive a first graphics workload;
a performance monitor configured to generate a first resource allocation for the first graphics workload;
a memory configured to store a first graphics workload identifier and the first resource allocation for the first graphics workload; and
a plurality of shaders for processing the first graphics workload,
wherein the control module is further configured to retrieve the first resource allocation and apply the first resource allocation to the plurality of shaders in response to the first graphics workload being received by the control module after storage of the first resource allocation.

14. The device of claim 13, further comprising:
a resource allocation module configured to allocate resources to the plurality of shaders in accordance with the first resource allocation.

15. The device of claim 14, wherein the performance monitor is to generate the first resource allocation by measuring processing demands on each of the plurality of shaders for processing the first graphics workload and allocating resources to each of the plurality of shaders based on the measurement of processing demands.

16. The device of claim 15, wherein the control module is further configured to retrieve the first resource allocation from the memory and send the first resource allocation to the resource allocation module.

17. The device of claim 15, wherein the resources comprise voltage applied to each of the plurality of shaders.

18. The device of claim 15, wherein the resources comprise clock frequency applied to each of the plurality of shaders.

19. The device of claim 15, wherein the resources comprise memory allocated to each of the plurality of shaders.

20. The device of claim 13, wherein the memory is a content addressable memory.
